(19) United States
(12) Patent Application Publication
(10) Pub. No.: US 2025/0094908 A1
(43) Pub. Date: Mar. 20, 2025

(54) EVALUATING IMPACT OF DATA FEATURE DELETION ON ASSOCIATED POLICIES

(71) Applicant: International Business Machines Corporation, Armonk, NY (US)

(72) Inventors: Shubhi Asthana, San Jose, CA (US); Ruchi Mahindru, Elmsford, NY (US); Bing Zhang, San Jose, CA (US)

(21) Appl. No.: 18/470,482

(22) Filed: Sep. 20, 2023

(51) Int. Cl. G06Q 10/0639; G06Q 10/067

(52) U.S. Cl. CPC G06Q 10/0639; G06Q 10/067

(57) ABSTRACT

A method, system, and computer program product obtain models pretrained on a set of features and map a set of policies to the models. A request to remove at least one feature from the features and, in response to the receiving, a policy from the set of policies that is affected by the at least one feature is identified. The identifying uses an association rule mining (ARM) model. Using a performance evaluation model, performance scores for the models with and without the at least one feature are generated. A reward function is calculated for the at least one feature based on the identifying and the performance scores. When it is determined that the reward function is greater than a threshold value, a recommendation is generated for a user.

### BACKGROUND

The present disclosure relates to machine unlearning and, more specifically, to evaluating and responding to the impact of data feature deletion on policies.

In enterprises, policies (e.g., rules) can be led by insights and predictions made by machine learning models trained on vast datasets. Altering or removing features used to train the models (e.g., in response to data removal requests, technical requirements, etc.) can change the predictions and trends made by these models, which can in turn affect the policies. Since these policies can be time sensitive, the models influencing them need to be dynamically maintained. However, existing technology does not adequately inform users of the impact on models and policies when features are deleted. This can cause changes in patterns and trends of which the users are unaware, preventing them from adapting/updating policies in a timely manner.

### SUMMARY

Various embodiments are directed to a method carried out by a processor communicatively coupled to a memory. The method includes obtaining models pretrained on a set of features and mapping a set of policies to the models. In some embodiments, the features are also mapped to the models. The method also includes receiving a request to remove at least one feature from the features and, in response to the receiving, identifying a policy from the set of policies that is affected by the at least one feature. The identifying uses an association rule mining (ARM) model. The method also includes generating, using a performance evaluation model, performance scores for the models with and without the at least one feature. This can allow potential problems with model performance to be predicted prior to deletion of the feature.

Further, the method includes calculating a reward function for the at least one feature based on the identifying and the performance scores and determining that the reward function is greater than a threshold value. The method also includes generating, in response to the determining, a recommendation for a user. Examples of generating the recommendation may include determining support for an association between the at least one feature and the policy, calculating a confidence for the association, notifying the user that a difference between performance scores for at least one of the models with and without the at least one feature being greater than a threshold difference, requesting human-in-the-loop training of the model, and/or notifying the user of the policy. The method can also include removing the at least one feature and retraining the models.

In some embodiments, multiple requests to delete selected features from the set of features are received. In response to receiving the multiple requests, a next recommendation can be generated for the user. For example, the next recommendation may include a suggestion that the selected features be deleted as a batch.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a block diagram illustrating a computing environment, according to some embodiments.

FIG. 2 is a block diagram illustrating a computing environment for evaluating and reacting to feature removal, according to some embodiments.

FIG. 3 is a flowchart illustrating a process of evaluating and reacting to the effects of feature deletion on policies, according to some embodiments.

### DETAILED DESCRIPTION

Aspects of the present disclosure relate generally to machine unlearning and, more specifically, to evaluating and responding to the impact of data deletion on policies. While the present disclosure is not necessarily limited to such applications, various aspects of the disclosure may be appreciated through a discussion of various examples using this context.

In information technology (IT) enterprises, policies (e.g., business rules) can be led by insights and predictions made by machine learning models trained on vast datasets. Altering or removing data instances can change the predictions and trends made by these models, which could in turn alter the policies. Since these policies can be time sensitive, the models influencing them need to be dynamically maintained. However, existing technology does not adequately inform users of the impact on models and policies when features are deleted. This can cause changes in patterns and trends of which the users are unaware, preventing them from adapting/updating policies in a timely manner.

Embodiments of the present disclosure may overcome these and other challenges by providing a way to determine whether or how machine learning models and policies (e.g., business rules) will be affected by deletion of features used to train the models. Policies can be mapped to models. When a feature removal request is received, an ARM model may be used to identify policies associated with the features. Additionally, one or more models that were trained on features identified in the request can be identified. Changes in performance of these models upon removal of the features can be predicted. If policies associated with features are found, and there is at least one model that will have a reduced performance after the features are removed, a recommendation can be generated. The recommendation can be provided to a user, notifying the user of the policies that may need to be revisited and/or models that may need to be retrained when the selected features are removed. In some embodiments, a human-in-the-loop can be utilized in order to mitigate a decrease in model performance caused by the feature removal.

Embodiments of the present disclosure are directed to a method carried out by a processor communicatively coupled to a memory. The method includes obtaining models pretrained on a set of features and mapping a set of policies to the models. An advantage of this can be that it allows correlations to be made between policies and models used by applications. In some embodiments, the features are also mapped to the models. This may allow models trained on a feature to be deleted to be easily identified. The method also includes receiving a request to remove at least one feature from the features and, in response to the receiving, identifying a policy from the set of policies that is affected by the at least one feature. The identifying uses an ARM model. The ARM model may advantageously determine associations between the policies and the feature to be deleted that could not be identified by a human. The method also includes generating, using a performance evaluation model, performance scores for the models with and without the at least one feature. This can allow potential problems with model performance to be predicted prior to deletion of the feature.

Further, the method includes calculating a reward function for the at least one feature based on the identifying and the performance scores and determining that the reward function is greater than a threshold value. An advantage of calculating the reward function can be that it takes into account both policies and models that may be affected by feature removal. This can give a more complete picture of what the results will be and what actions may need to be taken than, e.g., simply checking model performance.

The method also includes generating, in response to the determining, a recommendation for a user. This can inform the user of the effects of deleting the feature(s) so that the user may respond accordingly. Examples of generating the recommendation may include determining support for an association between the at least one feature and the policy, calculating a confidence for the association, notifying the user that a difference between performance scores for at least one of the models with and without the at least one feature is greater than a threshold difference, requesting human-in-the-loop training of the model, and/or notifying the user of the policy. The method can also include removing the at least one feature and retraining the models.

In some embodiments, multiple requests to delete selected features from the set of features are received. In response to receiving the multiple requests, a next recommendation can be generated for the user. For example, the next recommendation may include a suggestion that the selected features be deleted as a batch. This may improve efficiency when multiple requests are received because the deletion and retraining can take place in fewer steps than if each request were carried out individually.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The aforementioned advantages are example advantages and should not be construed as limiting. Embodiments of the present disclosure can contain all, some, or none of the aforementioned advantages while remaining within the spirit and scope of the present disclosure.

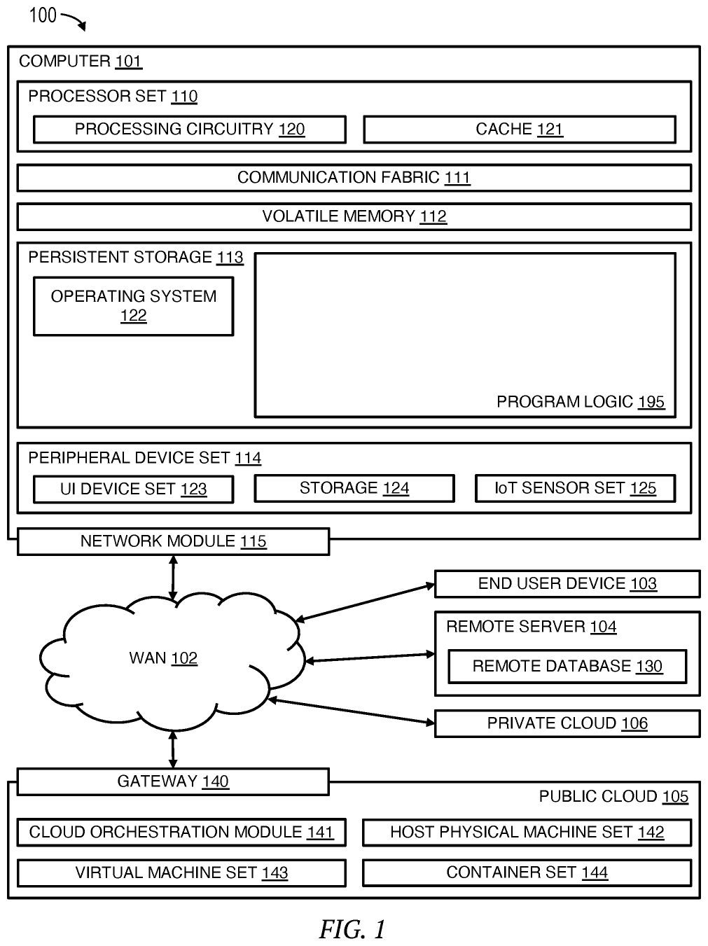

Turning now to the figures, FIG. 1 is a block diagram illustrating a computing environment 100, according to some embodiments. Computing environment 100 contains an example of a program logic 195 for the execution of at least some of the computer code involved in performing the inventive methods, such as training an ARM model to determine association rules from a set of pretrained models and policies and generating recommendations based on the rules. The program logic 195 may also determine the impact of deleting features of the pretrained models and utilize human-in-the-loop in response to determining that the deletion reduces model performance by a threshold amount. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

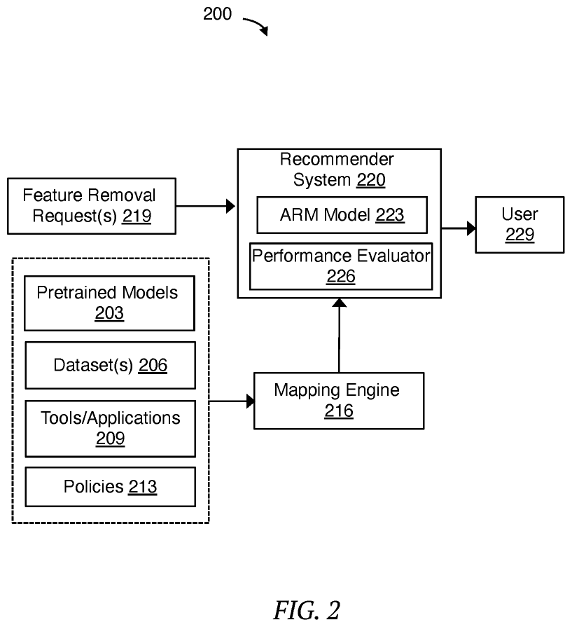

FIG. 2 is a block diagram illustrating a computing environment 200 for evaluating and reacting to feature removal, according to some embodiments. Computing environment 200 may implement program logic 195 (FIG. 1). Environment 200 may include a set of pretrained models 203, at least one dataset 206, and tools/applications (“applications”) 209 that use the pretrained models 203 and dataset(s) 206 (“dataset 206”). Examples of applications 209 may include, for example, a global purchase order tool, an invoices processing application, a purchase orders processing application, etc. However, any appropriate applications or tools 209 can be used, depending upon their intended purpose. The pretrained models 203 can be any models for implementing the applications 209. For example, the pretrained models 203 may include models for risk analytics, text classification, image processing, data mapping, etc.

The pretrained models 203 can be pretrained on features from the dataset 206. For example, there may be a predictive analytical model that provides predictions based on time series data, a classification model that identifies different categories of the data, etc.

Environment 200 can also include a set of policies 213, e.g., business policies, regulations, insights based on predictions made by the pretrained models 203, etc. In some embodiments, the policies 213 are in a data warehouse (“policy knowledge base”) that provides the list of policies. In some embodiments, the policies include business rules or processes, sets of regulations, etc. For example, the policies 213 may be business rules specifying “exclude invoices settlement data for Country A in risk modeling” (e.g., when “Country A” has unique data retention policies) or “expedite mainframe business unit's invoices every week”. In some embodiments, the policy knowledge base may be aided by human-in-the-loop. For example, policies 213 may be input into the policy knowledge base by a user.

The policies 213 may be encoded in computer code as business logic. Further, the policies may be expressed using modeling approaches such as Unified Modeling Language (UML), Business Process Execution Language (BPEL), Business Process Modeling Notation (BPMN), Z Notation, Semantics of Business Vocabulary and Business Rules (SBVR), Decision Model and Notation (DMN), etc. In some embodiments, the policies 213 may be in plain text.

Further, environment 200 can include a mapping engine 216, which can map features from each dataset 206 to models 203 trained on the features. Additionally, the mapping engine 216 can map the pretrained models 203 to policies 213. Association rule-based mapping may be performed between the pretrained models 203 and the policies 213 based on a database of the applications 209 implementing the pretrained models 203 and the policies 213. For example, a policy 213 such as “expedite mainframe business unit's invoices every week” may be associated with an invoices processing application and, therefore, mapped to the model(s) 203 used to train the invoices processing application. In further embodiments, the mapping engine 216 may map the pretrained models 203 to the policies 213 based on relationships extracted by, e.g., text analysis of the policies 213. For example, the policy 213 “exclude invoices settlement data for Country A in risk modeling” may be mapped to a model 203 for risk analytics.

Environment 200 can also include at least one data feature removal request 219. In some embodiments, a removal request 219 can be a request from an individual, an organization, an automatic instruction, etc. An example of a removal request 219 may be “remove mainframe server contracts for country: USA”. In further embodiments, a removal request 219 can be an automatic deletion trigger. For example, if a particular region has regulations that limit the amount of time personal identifying information can be retained, the removal request 219 may be generated for features (from the dataset 206) mapped to that region when the data has been stored for the maximum allotted time.

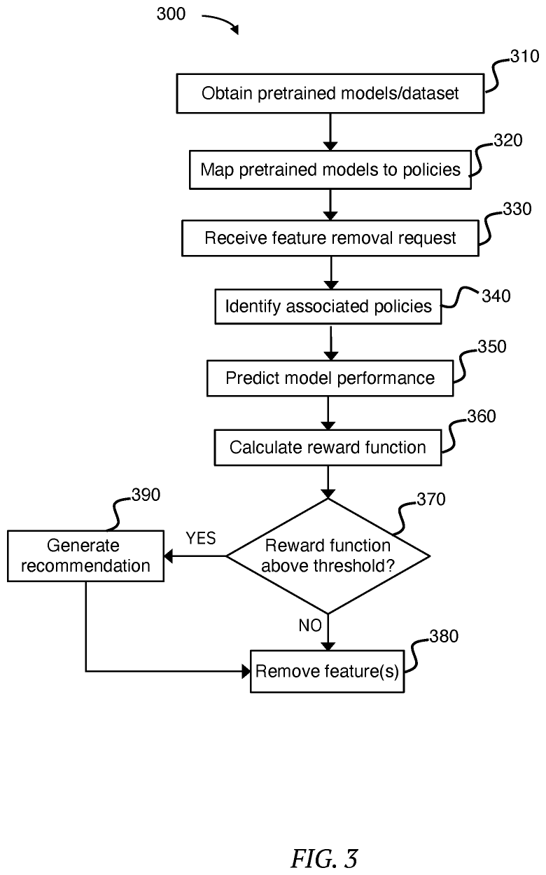

When the feature removal request 219 is received, a recommender system 220 can determine the extent to which the removal may affect policies 213 and/or models 203. The recommender system 220 can use an ARM model 223 to identify policies mapped to the features identified in the data feature removal request 219. The ARM model 223 may identify the policy/feature relationships with the greatest confidence scores. In the example above, the ARM model 223 may determine that the features (at least one feature from the dataset 206) identified by the removal request 219 “remove mainframe server contracts for country: USA” are mapped to the risk analytics model. In another example, the ARM model 223 may determine that removal of data such as “timestamp of order(s)” has a high impact on a policy specifying “orders must be delivered in 45 days”. Identifying policy/feature relationships by the ARM model 223 is discussed in greater detail below with respect to FIG. 3.

The recommender system 220 can also use a performance evaluator model 226 (“performance evaluator 226”) to determine how the performance of pretrained models 203 may change upon removal of the features identified in the removal request 219. For example, the performance evaluator 226 may use a model such as MLPerf to score performance of each model 203 mapped to the identified features before and after feature removal. Other techniques that may be used are discussed below. In some embodiments, only models 203 mapped to the feature(s) to be removed are tested by the performance evaluator 226. In other embodiments, the performance of all models 203 may be tested. The recommender system 220 can then generate a reward function based on the confidence scores determined by the ARM model 223 and the performance scores determined by the performance evaluator model 226.

If there is a policy mapped to the feature to be deleted with a confidence score above a threshold and there is a decrease in model 203 performance score after removal of the feature greater than a threshold decrease (a reward function above a threshold value), a recommendation may be output to a user 229. The recommendation may be a request that the user 229 review the feature removal request 219 before removing the features requested. Further, the recommendation may indicate which policies 213 will be affected by the feature removal. Based on the recommendation, the user 229 may adjust a policy, provide additional training to an affected model 203 (e.g., utilizing human-in-the-loop), etc.

FIG. 3 is a flowchart illustrating a process 300 of evaluating and reacting to the effects of feature deletion on policies, according to some embodiments. Process 300 may be performed by components of environment 200 and, for illustrative purposes, is discussed with reference to FIG. 2. A set of pretrained models 203 and at least one dataset 206 on which the models 203 have been trained can be obtained. This is illustrated at operation 310. In some embodiments, the pretrained models 203 can include at least one ML model/algorithm that can carry out techniques such as clustering, classifying, decision-making, predicting, etc. The pretrained models 203 can be used in a variety of applications 209 and are trained on input features from the dataset 206.

The pretrained models 203 can be mapped to a set of policies 213. This is illustrated at operation 320. The policies 213 may be mapped to the pretrained models 203 by a mapping engine 216. This is discussed in greater detail with respect to FIG. 2. While not shown in FIG. 3, each pretrained model 203 may also be mapped to features used to train the respective pretrained model. The models 203 may also be mapped to applications 209 that use the pretrained models 203.

A feature removal request 219 can be received. This is illustrated at operation 320. The removal request 219 can be a request from an individual, such as a system administrator, to delete a feature or set of features. The removal request 219 can also be automatically generated. For example, if a particular region has regulations that limit the amount of time personal identifying information can be retained, the deletion trigger may be generated for data mapped to that region when the data has been stored for the maximum allotted time.

The ARM model 223 can determine how the feature(s) to be removed may influence policies 213. This is illustrated at operation 340. The ARM model 223 can use rule learning to search for relationships among variables in datasets 206 of the pretrained models 203 and policies 213. The ARM model 223 can calculate the support s for a feature being associated with a policy and the confidence c of this association. The support s of a feature X in a model's 203 prediction history may be the percentage of rows in which feature X appears in a dataset 206. For example, the feature X may be “Country: USA”, and the support s of “Country: USA” over a set of predictions may be 1.0, indicating that a majority of the pretrained models 203 utilize the feature “Country: USA”. The support s can be calculated to approximate the probability that feature X is observed in policy Y, or the proportion of transactions that contain X U Y, as shown in Equation 1:

$$s ( X \geq Y ) = s ( X ⋃ Y ) \qquad ( 1 )$$

There may be a policy Y in the policies 213 such as “retain data for USA orders for 30 days after expiration”. In this example, the ARM model 223 may determine based on support s that policy Y is correlated with feature X (rule: X→Y). The ARM model 223 can calculate a confidence c of the rule X→Y to determine the strength of the rule (e.g., the number of times the rule is correct). If X→Y has a high confidence c, the rule is strong, and a set having X implies that Y will also be in that set. Therefore, if X is a model 203 feature to be deleted from a dataset 206, it can be inferred that policy Y will be influenced by the deletion based on the support s and confidence c values.

The association rule X→Y can be the association rule at a minimum support sₘᵢₙ and minimum confidence cₘᵢₙ, if the following conditions are satisfied:
Support s of X∪Y is at least sₘᵢₙ.
Confidence c of X→Y is at least cₘᵢₙ.
   In order to make recommendations on data to be unlearned, the top associations of policies with features can be selected by the ARM model 223.

The performance evaluator 226 can then determine how deleting the requested features may affect the pretrained models 203. This is illustrated at operation 350. The performance of each model 203 mapped to a policy 213 identified at operation 340 can be tested before and after feature removal. In some embodiments, the performance of all models 203 is tested at operation 350. For example, MLPerf and/or other performance evaluation techniques, e.g., F1 score, PR AUC (Precision-Recall Area Under the Curve), ROC AUC (Receiver Operating Characteristic AUC), LogLoss, etc., may be performed on the models 203. The difference in model 203 performance predicted to be caused by removal of the requested feature(s) can be determined using these techniques.

Based on the affected policies and model performance predictions determined at operations 340 and 350, respectively, the recommender system 220 can calculate a reward function Rₑ. This is illustrated at operation 360. The reward function Rₑ can be found using Equation 2:

$${R}_{e} = \sum f ( P , M ) \qquad ( 2 )$$

where P represents each policy affected by the feature removal, and M represents the change in model performance predicted at operation 350. For example, P can be 1 for each policy affected by feature removal or 0 for policies that are not affected, and M can be, e.g., a difference in model performance scores with and without features requested to be removed.

If the reward function Rₑ is below a threshold value (e.g., Rₑ<1), this indicates that the identified policies and/or model performances will not be substantially affected by the feature removal. In these instances (NO at operation 370), process 300 may proceed to operation 380, in which the features requested at operation 330 are removed. In some embodiments, the features are removed automatically, although the features may also be removed by a user 229 in response to a prompt at operation 380.

If the reward function Rₑ is at or above the threshold value (YES at operation 370), a recommendation may be generated. This is illustrated at operation 390. The recommendation may include a request for human-in-the-loop training. In some embodiments, the recommendation notifies a user 229 that deleting the requested data will cause at least one policy 213 and/or model 203 to be affected when Rₑ≥1. For example, the recommendation may include a list of affected policies and/or a list of models with performances predicted to decrease upon removal of the data requested at operation 330.

While not shown in FIG. 3, a recommendation may also be generated if repeated removal requests 219 are received within a given period of time (e.g., a day, a week, a month, etc.). This recommendation may include increasing the urgency of the feature removal and/or a suggestion that the requested features be removed as a batch rather than separately for each request. In these embodiments, the recommendation may be output to the user 229 whether or not the reward function is above the threshold at operation 370.

When the recommendation has been generated, process 300 may proceed to operation 380, and the requested features can be removed. In some embodiments, the feature removal must be approved by a user 229 in response to the recommendation at operation 370 before being removed at operation 380. In other embodiments, the features may be removed automatically at operation 380.

After feature removal at operation 380, process 300 may end. In some embodiments, the model(s) 203 may be retrained after the features are removed at operation 380. Various machine unlearning models may be used to remove the requested features and retrain the pretrained models 203. Retraining the models 203 may include human-in-the-loop, such as input from subject matter experts. In further embodiments, process 300 may return to operation 330 to receive a next data removal request 219 upon removing the requested features and/or retraining the pretrained models 203. As discussed above, a recommendation may be generated if a number of requests 330 greater than a threshold number (e.g., greater than or equal to 2, 5, 10, 50, 100, etc. requests) are received within a given period of time.

Although business and regulatory examples have been used to illustrate embodiments of the invention, the invention provides technical solutions that can be applied in various contexts. For example, techniques described herein may be applied to a variety of models in order to determine the impact of data deletion. This may allow problems arising from deletion of features to be detected and addressed efficiently in machine learning applications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the present disclosure.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. However, the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, and item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; ten of item C; four of item B and seven of item C; or other suitable combinations.

What is claimed is:

1. A method, comprising:
obtaining, by a processor communicatively coupled to a memory, models pretrained on a set of features;
mapping, by the processor, a set of policies to the models;
receiving, at the processor, a request to remove at least one feature from the features;
in response to the receiving, identifying, by the processor using an association rule mining (ARM) model, a policy from the set of policies that is affected by the at least one feature;
generating, by the processor using a performance evaluation model, performance scores for the models with and without the at least one feature;
calculating, by the processor, a reward function for the at least one feature based on the identifying and the performance scores;
determining, by the processor, that the reward function is greater than a threshold value; and
generating, by the processor and in response to the determining, a recommendation for a user.

2. The method of claim 1, wherein the calculating the reward function comprises determining support for an association between the at least one feature and the policy.

3. The method of claim 2, wherein the calculating the reward function further comprises calculating a confidence for the association.

4. The method of claim 1, wherein the generating the recommendation comprises notifying the user that a difference between performance scores for at least one of the models with and without the at least one feature is greater than a threshold difference.

5. The method of claim 1, wherein the generating the recommendation further comprises requesting human-in-the-loop training of the model.

6. The method of claim 1, wherein the generating the recommendation comprises notifying the user of the policy.

7. The method of claim 1, further comprising mapping the set of features to the models.

8. The method of claim 1, further comprising:
removing the at least one feature; and
retraining the models.

9. The method of claim 1, further comprising:
receiving multiple requests to delete selected features from the set of features; and
in response to the receiving the multiple requests, generating a next recommendation for the user.

10. The method of claim 9, wherein the next recommendation comprises a suggestion that the selected features be deleted as a batch.

11. The method of claim 1, wherein the set of policies comprises business rules.

12. A system, comprising:
a memory; and
a processor communicatively coupled to the memory, wherein the processor is configured to perform a method comprising:
obtaining, by the processor, models pretrained on a set of features;
mapping, by the processor, a set of policies to the models;
receiving, at the processor, a request to remove at least one feature from the features;
in response to the receiving, identifying, by the processor using an association rule mining (ARM) model, a policy from the set of policies that is affected by the at least one feature;
generating, by the processor using a performance evaluation model, performance scores for the models with and without the at least one feature;
calculating, by the processor, a reward function for the at least one feature based on the identifying and the performance scores;
determining, by the processor, that the reward function is greater than a threshold value; and
generating, by the processor and in response to the determining, a recommendation for a user.

13. The system of claim 12, wherein the calculating the reward function comprises:
determining support for an association between the at least one feature and the policy; and
calculating a confidence for the association.

14. The system of claim 12, wherein the generating the recommendation comprises notifying the user that a difference between performance scores for at least one of the models with and without the at least one feature is greater than a threshold difference.

15. The system of claim 12, wherein the generating the recommendation further comprises requesting human-in-the-loop training of the model.

16. The system of claim 12, further comprising:
receiving multiple requests to delete selected features from the set of features; and
in response to the receiving the multiple requests, generating a recommendation that the selected features be deleted as a batch.

17. A computer program product, the computer program product comprising a computer readable storage medium having program instructions embodied therewith, the program instructions executable by a processor to cause a device to perform a method, the method comprising:
obtaining, by the processor, models pretrained on a set of features;
mapping, by the processor, a set of policies to the models;
receiving, at the processor, a request to remove at least one feature from the features;
in response to the receiving, identifying, by the processor using an association rule mining (ARM) model, a policy from the set of policies that is affected by the at least one feature;
generating, by the processor using a performance evaluation model, performance scores for the models with and without the at least one feature;
calculating, by the processor, a reward function for the at least one feature based on the identifying and the performance scores;
determining, by the processor, that the reward function is greater than a threshold value; and
generating, by the processor and in response to the determining, a recommendation for a user.

18. The computer program product of claim 17, wherein the generating the recommendation comprises notifying the user that a difference between performance scores for at least one of the models with and without the at least one feature is greater than a threshold difference.

19. The computer program product of claim 17, wherein the generating the recommendation further comprises requesting human-in-the-loop training of the model.

20. The computer program product of claim 17, further comprising:
receiving multiple requests to delete selected features from the set of features; and
in response to the receiving the multiple requests, generating a recommendation that the selected features be deleted as a batch.
